(19) United States
(12) Patent Application Publication
(10) Pub. No.: US 2020/0020030 A1
(43) Pub. Date: Jan. 16, 2020

(54) SYSTEM AND METHODS FOR CARRYING OUT OBJECT-BASED TRANSACTIONS USING SECURITIES

(71) Applicants: Valeriy Ivanovich STARODUBTSEV, (US); Asia STARODUBTSEVA, Tianjin, Hebei (CN)

(72) Inventor: Valeriy Ivanovich Starodubtsev, Novosibirsk (RU)

(21) Appl. No.: 16/470,259

(22) PCT Filed: Dec. 6, 2017
(86) PCT No.: PCT/RU2017/000908

§ 371 Date: Jun. 17, 2019

(30) Foreign Application Priority Data
Dec. 16, 2016 (RU) 2016149603

(51) Int. Cl. G06Q 40/04; G06Q 40/06

(52) U.S. Cl. CPC G06Q 40/04; G06Q 40/06

(57) ABSTRACT

The invention refers to the system and methods of transactions with objects. Technical result—protected automation of operations with objects. The system contains the terminals of traders connected through the communication network, the authorization server and the preparation of the securitization, forming the form of the basis assets of the object and the securitization, the securitization server, which produces the securitization of objects, issue of many securities, the generation of securities identifiers, the server of transactions with securities, where securities are subject to transactions, using the calculation server, broker's server, dealer, depository server, trader's terminal, accounts of participants trades, trading and external accounts of traders.

The present invention refers to the system and methods of transactions with objects, including real estate objects, created objects and/or being created objects and/or with the formed land plots, using securitization, issue of securities, Purchase-sale of many separate securities, including derivatives of the underlying (basis) asset-unit dimension of the object, including derivatives of the obligation to sell the basis asset and/or encumbrance of rights.

There is a patent 2449369 RU, a system of real estate transactions, which uses securities for real estate, and its way, which refers to the system and method of real estate transactions. The technical result is an increase in the reliability of real estate transactions, through securitization of property, and the sale of many separate securities, which include a valuable paper on the right of ownership and a valuable paper on Investment. This invention is taken for the prototype. In the invention taken for the prototype is not obvious performance of the task, which is stated in the abstract and in a technical result, namely, the sale of securities, including the security of the title. Based on the prototype formula and the description of its implementation, it can be seen that there are no formulations-“security of ownership”, which is referenced in the abstract of the prototype invention.

As a matter of fact, a company of 20 special purpose real estate trade or a separate trust company buys real Estate, becomes the owner of this real estate, and then manufactures and trades in the right of lease with the right of resale of lease and Investments either in the company of 20 special-purpose or in a trust company.

A company of 20 or a trust company, securitization and issuing securities for the right of abode and investment, receives investment and sells the right of residence, while the ownership of the property remains with the company of 20 or the trust Company. When the market is monopolized by a company of 20 or a trust company, the market value of securities is actually lost, as it will be predetermined by the monopolist in the market and depend on the needs of the monopolist.

There is a possible disadvantage, which makes it difficult to realize the invention taken for the prototype under antimonopoly legislation of different countries, as the company of 20 special-purpose buys all property for the securization, and the right of ownership leaves behind itself, it will lead to monopolization of the real estate market that contradicts to antimonopoly legislation. The invention of the prototype infringes the rights of the owner of the property, as it does not allow to use him real estate in the his of the realization invention for the taken, and prototype monopolizes right by the company of 20 or its company. If we assume that after the implementation of the prototype method there is a sale, resale and re-registration of property rights in a short period of time, in real time, actually instantly and can be repeated, as it is provided by the exchange trade, it is not possible in the framework of the invention taken for the prototype, as in many countries, including in those where the invention is registered for the prototype, there is a State registration Property rights, the Formalization of these rights is governed by laws and requires more time to register property rights than is assumed in the invention of the prototype.

Obviously, the right of ownership is different from the right of residence, and the right to own capital for real estate from the right to invest, these are different notions and securities derived from these rights are different, respectively having different law and legal consequences. In the formula of the invention taken for the prototype, in the System section and section the method realizing the work of the system, there is no wording of the “security of ownership”. According to the rules, the invention formula must contain the characterization of the invention as a totality of its characteristics, determining the scope of legal protection granted by the patent.

Similarly, the above invention, taken for the prototype, based on its description, takes into account only the created and registered real estate, does not take into account and does not include the system and method of transactions with the being created real estate and/or with being formed land plots, as well as with being created objects and created objects in general.

Frozen capital in objects, including real estate objects, requires the same attention as the capital in such goods as oil or gas.

Existing systems and methods of transactions with objects, including those being created objects using securities, including those in the real estate segment, do not meet the requirements of the growing market of securities, including the real estate market, the requirements Application of innovations and new technologies of acceleration of transactions, requirements of operative use of the own capital frozen in objects, operative investment and trade, including in a mode of real time. Accordingly, there is a need for a new system and methods of transactions with objects, including real estate, allowing the greatest satisfaction of the needs of all parties of the transaction process.

To solve the above-mentioned problems associated with traditional transactions with objects, including real estate transactions, and to provide a variety of additional benefits, 1) The proposed invention is directed to the system and method of transactions With the objects being created, which use securitization of rights to the object being created, including the created real estate object and/or the formed plot of land, in which by means of a server of the securitization it accepts the information from the authorization server and preparation of the securitization and form securities, including derivatives of the basis asset—units of measure of the object and/or obligation to sell the basis asset and/or encumbrance of the rights of sale of the basis asset that are subject to transactions, through the auction or exchange of securities, upon completion of the creation of the object as a whole, the transfer of securities to the ownership of the object (expiration date) is made. Expiration is the date of completion of the transaction.

Expiration is the process of completion of the circulation of urgent contracts (futures and options) on the Exchange. An expirating is actually a date when obligations are fulfilled (i.e., an asset is delivered and/or mutual settlements between the parties to the transaction).

2) The present invention is also directed to the system and method of transactions with objects, using securitization of rights to the object, in which the securitization server shares the right to the object on the right of ownership and the right of own capital, forms relevant securities, including derivatives of basis assets and/or liabilities for the sale of basis assets and/or encumbrance of the rights of sale of basis assets that expose transactions through an auction or exchange of securities.

3) The present invention is also directed to the system and method of transactions with objects, which use securitization of rights to the object, in which the securitization server shares the right to the object of ownership and the right of own capital and forms relevant securities, including derivatives, with which one security of ownership reflects the right to one basis asset within its cost, and one security of equity rights reflects the right to surplus value one basis asset, securities, including derivatives are subjected to transactions, through auction or exchange securities.

4) The present invention is also directed to the system and method of transactions with objects using the stage of preparation of securitization, on which the server of authorization and preparation of securitization forms the encumbrance of the existing rights of the seller to the object, including on the object being created, registers the encumbrance of the rights of sale of the underlying asset, generates the identifier of this information and adds it to the previously generated identifier (trader/seller/object), to transfer this information to the server securitization, which form the relevant securities, including derivatives and generate for each identifier complementary with the IDs generated by the authorization server and the preparation of securitization, it gives the opportunity to multiple, easy and secure purchase and sale of securities through an auction or exchange.

The system of deals with objects presented in the invention, including those created by objects, is a new, using the servers allowing realization of technical problem leading to the technical result—protection against repeated sales of the object.

The ways of realization of the system of transactions with objects presented in the invention are new, including the way of transactions with the created objects using the software division of rights on the object on the basis assets—units of its measurement, further programmatic, using a new method of securitization—formation, issue of securities and derivatives, protected by the code-identifier of encumbrance, automated sale of these securities, leads to realization of technical problem leading to technical result is protection against repeated sales of the object.

The method presented in the invention for dividing an object for a system of deals with objects, including thous being created objects, using securities, for functioning in the trading system, by allocating in the object the basis assets-units of its measurement, as well as dividing the whole right to the object to the constituents, where the right of ownership determines the component of the right to the object, as the right to use the object and ownership of this right, and the right of own capital to the object determines the component capital in this facility, at the same time, one security paper of title to an object may reflect the right to one basis asset, within its cost, and one security paper of the right to own capital to an object may reflect the right to the surplus value of one basis asset, also in all the varieties protected by the code—the identifier of the burden, this leads to a technical result—protection from unauthorized repeated sales of the object.

The first aspect of the present invention provides for a system of transactions with objects, including with created objects, including traders' terminals connected through a communications network, an authorization server and securitization preparation for authorizing transaction participants, evaluating and burdening existing rights to the created and/or being created object, dividing the object into basis assets, preparing securitization, securitization server for receiving information from the authorization server and preparing securitization, dividing the rights to the object by avo property and the right to own capital, securitization of rights to multiple securities, transfer information to the server of securities transactions in the trading system, server transactions in securities for receiving information, authorizing all parties and objects of the transaction, registering purchase and sale transactions, transferring information all parties to the transaction, a settlement server for registering participants in the transaction, forming their accounts, effecting settlements between them, depositing and withdrawing funds, saving and protecting, receiving and transmitting information.

The system can additionally include a broker server executed by the software and hardware complex receiving information about the security from the server of transactions with securities, accepting applications for purchase and/or sale of securities from the trader's terminal, Transfer applications for purchase and/or sale of security paper to the server of securities transactions of the trading system, transferring information about transactions and securities to the trader's terminal, ensuring the preservation and protection of information.

The system may additionally include the depositary server performed by the software and hardware complex receiving information from the securitization server, storing, keeping records, distribution of securities, updating rights to securities, receiving information about securities and trading transactions with securities from them. system and transmitting information to it, as well as to the broker's server, ensuring the preservation and protection of information.

The broker's server may include a hardware and software complex which additionally transmits the information about the security to the depository server.

The second aspect of the present invention provides for a method of dividing an object for a system of transactions with objects, including being created objects, using securities for functioning in a trading system, by dividing an object into basic assets—its units of measure, as well as dividing the whole right to an object into components by functions, where the right of ownership determines the component of the right to an object, as the right to use the object and the ownership of this right, and the right of own capital to the object, determines investing capital in this property, while securitizing derivative divisions into securities, including securities of the prime cost of the basis asset and securities of the surplus value of the basis asset, while one asset of ownership reflects the right to one basis asset within its cost, one security of equity rights reflects the right to the surplus value of one basis asset.

The third aspect of the present invention provides for the way of deals with ready objects. The method provides for transactions between the terminals of traders of objects and own capital of buyers, through the network of communication, the way includes: the stage of authorization and preparation of the securitization, on which take the information about the object and its trader, authorize the participants of transactions, generate identifiers, form the assessment, the obligation of

securitization and sale of the object, encumbrance of the seller's rights on the object, divide the object into the number of basis assets-units of its measurement, form the sales price, generate the identifier (trader/seller/object/encumbrance/basis asset), the information is stored in the database and transferred to the server the securitization;
stage of securitization, for receiving information and dividing the rights to the object, at the right ownership and the right to own capital and securitization of these rights, through the securitization server, into a variety of securities, including derivatives of the basis asset and/or obligation to sell the basis asset and/or encumbrance the rights of the seller to the object, the generation of identifiers for securities complementary to the identifiers generated by the authorization server and the preparation of securitization, registration and storage of securities, protection and transfer of information to the server of securities transactions in the trading system;
stage of circulation of the securites, for reception of the information on a securites on a server of transactions with securities of trading system, authorization of Parties and objects of transactions, provision of storage of the information, record on trading accounts of participants of the transaction information on Purchase and sale of securities, exchange of information on the parties of the transaction and actions with the security between the server of transactions with securities of the trading system, the server of settlements and the trader's terminal;
stage of settlements and circulation of funds, for reception by the server of settlements from bidders and transactions with securities, the funds on their trading accounts and information, on actions with security, from the server of transactions with securities, settlements and Payments to direct participants of the transaction, according to the results of purchase and/or sale of securities, and/or calculations and payments to indirect participants of the transaction for the work performed, by crediting to the account of the participant of the transaction and/or debiting from his account, protect and preserve information about the parties to the transaction and the actions with the funds.

Method may additionally include the phase of dividing the object, its underlying assets, securities, including securities, ownership rights, equity and/or derivatives, through the securitization server, on securities—cost of the basis asset and securities—surplus value of the basis asset, with one security paper property of the right of ownership reflecting at least the right to one basis asset with in its cost, and one security paper on equity capital rights reflects at least the right about on the surplus value basis asset.

Method may additionally include a stage of calculation through the calculation server, dividends from the profit of the use of the object, which is divided between securities ownership rights and securities of the right of equity in accordance with their shares in the object and/or predetermined dividend conditions.

The fourth aspect of the present invention provides for a method of transactions with being created objects, including being created real estate objects and/or being formed land plots. The method involves transactions between the traders ‘terminals of the objects being created and the customers’ own capital, through a communication network, the method includes: the authorization and preparation securitization stage, where receive information about the object being created and its trader, authorize participants of transactions, generate identifiers A for them, form an assessment, an obligation securitization sales on object being created, an encumber the seller's right to the object being created, divide the object being created into its constituent number basis assets—units of measure, form the sale price, generate ID AB (trader/retailer/being created object/encumbrance/basis asset), the information is stored in the database and transferred to the securitization server;

the stage of securitization for the formation for the transaction with being created object of securities, including derivatives of the basis asset and/or the obligation to sell the basis asset and/or encumbrance of the seller's rights on the being created object, for generate ABC ID for the securities, complimentary with AB ID generated by the authorization server and preparation of the securitization, registration and storage of securities, protection and transfer of information to the server securities transactions in the trading system;

the stage of securities circulation for reception of information about a securities on a server of transactions with securities of trading system, authorization of parties and objects of transactions, provision of storage of information, recording on trading accounts of participants of transaction information on purchase and sale of securities, exchange of information on the parties of the transaction and actions with the security between the server of transactions with securities of the trading system, the server of settlements and the trader's terminal;

the stage of settlement and circulation of funds for receiving, through the settlement server from bidders and securities transactions, monetary funds in their trading accounts and information on actions with securities from the securities trading server, settlements and payments to direct participants in the transaction based on the results of the purchase and/or sales of securities and/or a settlement period, settlements and remuneration payments to indirect participants in a transaction for work performed by crediting to the account of a transaction participant and/or debiting about an the relevant accaunts, ensuring the protection and preservation of information about the parties to the transaction and actions with funds.

Brief description of the variants of the system and ways of realization of the invention with reference to the attached drawings on which:

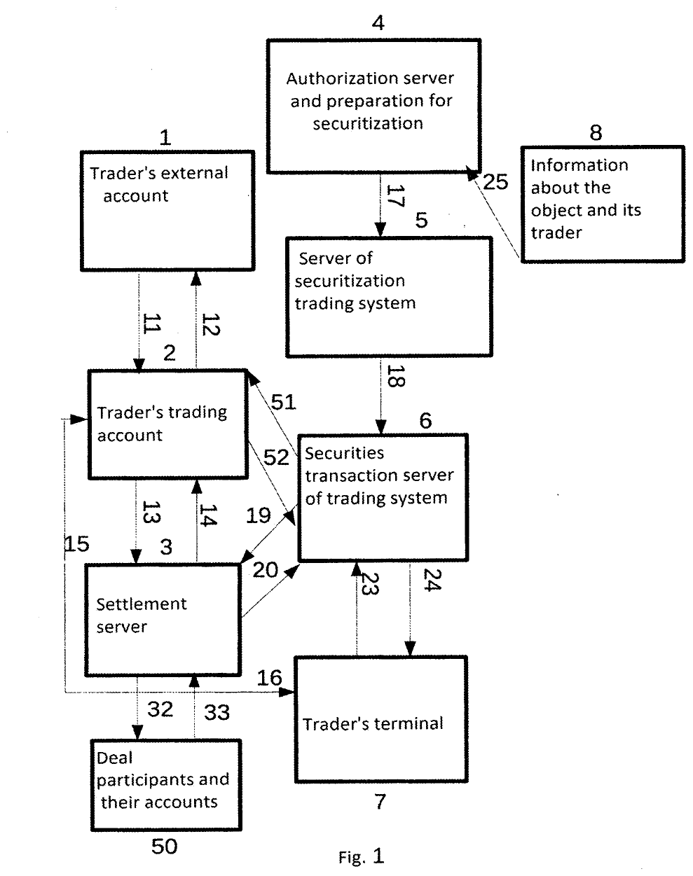

FIG. 1—The structural scheme of the first variant of the system and the method of its implementation illustrating the concept of the present invention;

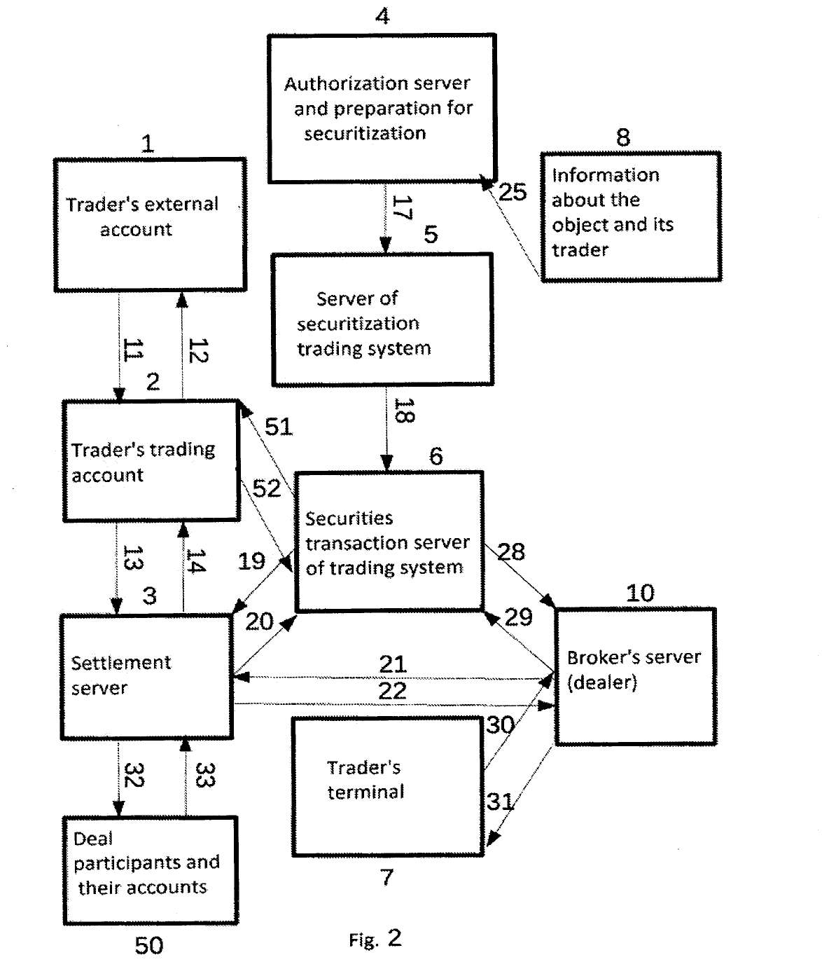

FIG. 2—The structural scheme of the second variant of the system and the method of its implementation illustrating the concept of the present invention;

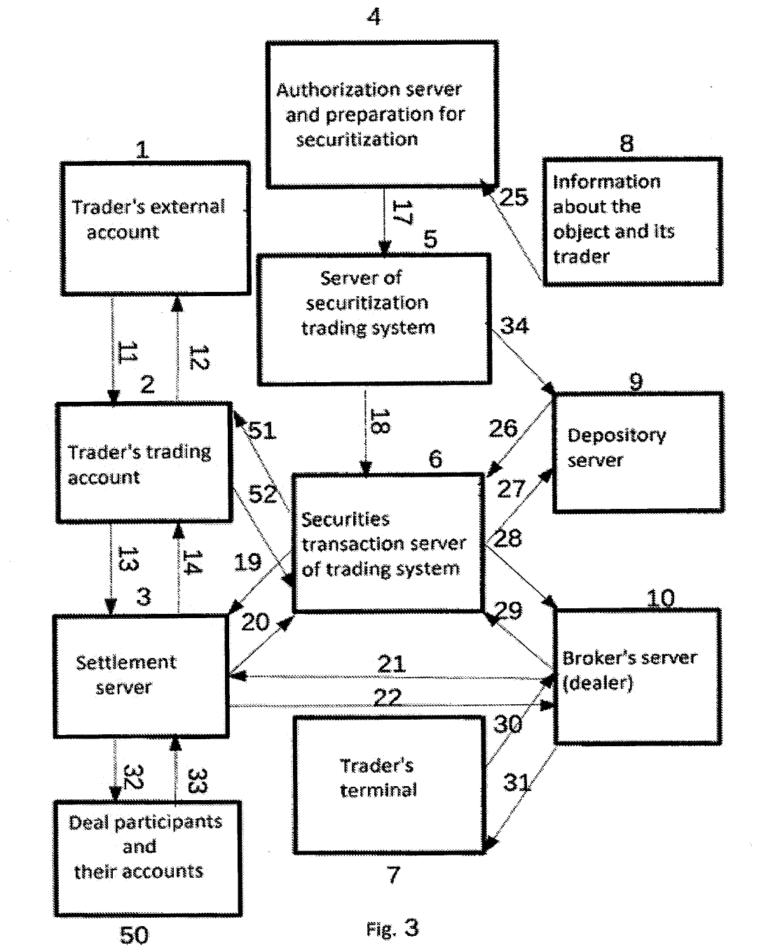

FIG. 3—The structural scheme of the third variant of the system and the method of its implementation illustrating the concept of the present invention.

Embodiments of the present invention will be described with reference to the accompanying drawings. Description of the implementation of the invention will be disclosed if possible by the example of real estate, but this does not mean that the options of the system and methods of implementation are applicable only to real estate. The present invention is not limited to the embodiments disclosed below and can be implemented in various forms.

Due to the fact that the level of technology is rapidly changing and it is impossible to foresee all possible combinations of software-hardware complexes components corresponding servers presented in the invention. As a basis we shall take that all servers in the proposed invention are represented by software and hardware complexes necessary and sufficient on the level of technics and correspond to a temporary period of their use for realization of the present invention.

FIG. 1—illustrates the structural scheme of the first variant of the system and how it is implemented.

With reference to FIG. 1, the first variant of the system includes: the authorization and securitization preparation server executed by the software-hardware complex 4, carrying out the stage of authorization and preparation of securitization; securitization server executed by software-hardware complex 5, for implementation of the stage of securitization of the created object and the stage of securitization of the being created object; securities transactions server presented by the software and hardware complex 6, for the implementation of the stage of the securities circulation; calculation server 3 presented by the software and hardware complex, for the implementation of the calculation stage; trader terminal 7, presented by software and hardware complex, for interaction of trader with trading system; trading account of trader 2, for crediting and storage of funds and/or securities and execution of transactions; trader's external account 1, for entering and withdrawing funds into and out of the system; accounts of the participants of the transaction 50, for settlements between direct and indirect participants of the transaction and trading system.

With reference to FIG. 1, we shall consider functioning of the system and the server of authorization and preparation of securitization 4, performing the stage of authorization and preparation of securitization of the way on which accept 25 information about the object and its trader 8 necessary for Preparation of securitization. On server 4 authorize both trader of the object, and trader of the buyer, participants of 50. Participants can be for example: brokers, dealers, valuers. On server 4, you generate an identifier for each participant and object, machine-readable code, for example, a letter-numeric code a trader, AB trader/seller. This code may consist of parts of the ABC trader/seller/object and be generated jointly for the trader/seller/and its object. Based on the information received form the securitization of the object. The information about the object includes all the necessary information for securitization of this object. Server presented by the software and hardware complex, for the implementation of the stage. On server 4 the best variant of securitization of each object is selected, for this purpose it is divided created and/or being created object, including the object of real estate and/or land plot on the basis of its number of base assets-units of its measurement. The unit of measure on the example of a real estate object can be presented in different ways. For example: for a unit of measurement of real estate It is possible to take a square metre or cubic metre, as well as possible relation of derivatives from such parameters as time of residing or use to area and comfort of object. In other cases, the unit of measure may reflect the quantitative and/or qualitative and/or value or other applicable dimension of the object. Generate code D for each underlying asset to the trader/seller/object code by getting the ABCD of the trader/seller/object/basis asset.

On server 4 accept the valuation of assets 25 from trader-seller 8. Form the valuation of assets based on information 25 estimates from appraisers. Form the obligation of securitization and sale of both the object and its underlying assets, which may have the form of a contract between the trader-seller, the holder of rights to the object created or the owner of the object, represented as a natural person, so and a legal entity having rights to the object or its creation and trading system, the representative of the trading system. This contract provides for the encumbrance of the seller's existing rights to the object, including the object being created.

On server 4, register and store incoming and generated information, register encumbrance, generate the code E encumbrance to the corresponding trader/seller/object/basis asset ID, receiving the ABCDE trader/seller/facility/underlying asset/encumbrance, forming this protection against repeated sales. Through server 4 can carry out insurance of transactions, the object both created and created. Server 4 transmits information 17 to the securitization server 5 via communication channels.

The form of securitization for created and being created object is different.

With reference to FIG. 1, we will consider the functioning of the system and the securitization server during the stage of securitization of the being created object.

Through the securitization server 5 take information 17 from the authorization server and the preparation of securitization 4. With the help of the securitization server 5 at the stage of securitization of the being created object form securities, including derivatives of the basis asset and/or the obligation to sell the basis asset and/or encumbrance of the seller's rights to the object. Through the securitization server 5 generate an S—identifier for each security paper, complimentary with the ID generated on the authorization server and preparation on securitization 4, receiving for example: ID of the SABCDE of the security/trader/seller/created object/basis asset/encumbrance. Through the securitization server 5 register, protect, store and transmit information 18 to the server Securities transactions 6 trading system.

With reference to FIG. 1, we will consider the functioning of the system and the securitization server during the securitization stage of the created object.

Through the securitization server 5 take information 17 from the authorization server and the preparation of securitization 4. With the help of the securitization server 5 are divided an whole right on object to the right property on the object and the right of own capital an object. The right of ownership determines the component of the right to object, as the right to use the object and ownership of this right. The right of own capital to the object determines the component of the right to the object as the right to material and other investments in this object and ownership of this right. On the securitization server 5 securitization of the property right and the right of equity to the object in securities, including derivatives of the basis asset and/or the obligation to sell the basis asset and/or encumbrance of the seller's rights to the object.

Through the Securitization server 5 generate an identifier for each security, including the Q ID of the property right and the W ID an right equity, which is complementary to the identifier generated by the authorization server and securitization preparation 4, obtaining a code, for example: QSABCDE—security paper identifier of title—/trader/seller/object/basis asset/encumbrance/, or WSABCDE—equity identifier of equity right/trader/seller/object/basis asset/encumbrance/. Through the server securitization 5 register, protect, save and transmit information 18 to the server transactions with securities 6 of the trading system.

With reference to FIG. 1, consider the functioning of the system and the server of transactions with securities 6 in the implementation of the stage of circulation of securities.

Through the server of transactions with securities 6 accept information 18 about securities and participants of transaction, authorize participants and objects of transactions, accept 23 applications of purchase and/or sale of securities from terminal of trader 7, accept information 20 about Synchronization of transactions from the calculation server 3. The Securities Transactions Server 6 of the trading system processes applications 23. On the server of transactions with securities 6 trading system register the conclusion of the transaction of purchase and sale of security at coincidence of supply and demand.

Through the server of transactions with securities 6 trading systems inform 24 to the terminal of trader 7, inform 19 on the server of calculations 3, inform 51 on trading account of trader 2 about the fulfillment of the transaction and transfer of rights to securities and funds. By means of a server of transactions with securities 6 store the information on the parties of the transaction and actions with a securities.

With reference to FIG. 1, consider the operation of the system and the calculation server 3 in the implementation of the calculation phase.

Through the calculation server 3 register authorized participants of the transaction, form and register the account of the participant of the transaction, trading account of the trader in the trading system, make the transaction of funds 11 from the external account of Trader 1 (from the bank account) on trading account of trader 2 in the trading system and further supply information 13 about money from trading account of trader 2 on the calculation server 3.

Transmit information 15 about the funds and actions with them from the trading account of trader 2 to the terminal of the trader 7. Settlement server 3 delivers information 20 about fixing funds on the trading account of trader 2 to buy securities to the server of securities transactions 6 of the trading system and accepts information 19 from the server of transactions with securities 6 of the trading system about the transaction. Settlement server 3 performs all calculations, payments, and delivers information to the trader's trading account 2 about changes in cash rights resulting from the sale and/or purchase of a security.

Settlement server 3 is represented with recording money 14 on the trading account of the trader—seller of the security 2 and write-off funds 13 from the trading account of 2 trader—the buyer of the securities. Settlement server 3 is represented by withdrawing 12 funds from the trading system through trading account of trader 2 on the external account of trader 1 (bank account). Settlement server 3 is represented by calculating and recording 32 on the account of 50 funds. This is a reward for the work he or she has done under the terms of the trading system. Through the settlement server, 33 funds are debited from the accounts of the participants of the transaction 50 for the services, rendered to them by the trading system for bidding according to the terms of the trading system.

Settlement server provides protection and preservation of information about parties to the transaction and actions with funds.

Securities and/or cash may be on the trader's trading account.

With reference to FIG. 1, consider the operation of the system and the terminal of the trader 7 in it. The terminal of the trader is represented by a software and hardware complex 7 by means of which submit applications 23 for the purchase and/or sale of a securities to the server of transactions with securities 6 of the trading system. Terminal 7 is presented to receive information about the wiring of funds 11 from the trader's external account 1 and information 12 about the wiring of funds to the trader's external account 1, through the trader's trading account 2 of the trading system, by transferring information 15 from the trader's trading account 2 to the trader's terminal 7 information 16 from the trader's terminal 7 to the trader's trading account 2. Terminal 7 is represented by the receiving information 24 on sale and/or purchase of the security from the server of securities transactions 6 trading system and transferring this information 16 from the trader's terminal to trader's trading account 2. Terminal 7 is represented by the sending order 16 for sale or cancellation of sale or purchase of securities on trading account of trader 2, and from trading account 2 transfer of this information 52 to the server of transactions with securities. Terminal 7 provides information preservation and protection.

FIG. 2—illustrates the structural scheme of the second variant of the system and the method of its implementation.

With reference to FIG. 2, the second version of the system includes: authorization server and securitization preparation executed by hardware and software complex 4, carrying out the stage of authorization and preparation of securitization; securitization server executed by software-hardware complex 5, for implementation of the stage of securitization of the created object and the stage of securitization of the being created object; the securities transactions server presented by the software and hardware complex 6, for the implementation of the stage of the securities circulation; settlement server 3 represented by a software and hardware complex, for the implementation of the calculation phase; broker (dealer) server represented by software and hardware complex 10, for the implementation of competent interaction of traders with the trading system; terminal of trader 7 represented by software and hardware complex, for the interaction of the trader with the broker (dealer) server 10; trading account of trader 2, for crediting and storing cash and/or securities and transactions; trader's external account 1, for depositing and withdrawing funds into and out of the system; accounts of participants in the transaction 50, for settlements between direct and indirect participants in the transaction and the trading system.

With reference to FIG. 2, the operation of the authorization server and the preparation of securitization 4, which performs the stage of authorization and preparation of securitization, and the securitization server 5, which performs the securitization stage of the being created object or the securitization stage of the created object, in the second variant of the system is carried out in the same procedure and methods of implementation as they were described earlier in the functioning of the system according to the flowchart of the illustrated FIG. 1.

The second version of the system and method of its implementation includes the Broker's server (dealer) 10.

Referring to FIG. 2, we consider a method of operating a system and a server for transactions with securities 6 during the implementation of a stage for circulation of a securities.

Through the server of transactions with securities 6, receive information 18 about securities and participants of the transaction from server 5, authorize participants and objects of transactions, accept 29 applications for buying and/or selling securities from a broker (dealer) server 10.

If the object is a real estate, a representative of a trading system, a broker (dealer) can be a dealer and/or a real estate agency having a relevant permit or license.

Through the server of transactions with securities 6, the trading system receives information 20 about synchronizing settlements of transactions from the settlement server 3. On the server of transactions with securities 6 of the trading system, a purchase and sale transaction of a security is recorded when supply and demand coincide.

Through the server of transactions with securities 6 of the trading system, inform 19 on the settlement server 3 about the transaction with securities, inform 28, via a communication channel, to the server of the broker (dealer) 10 about the transaction with securities, inform 51, to the trading account of the trader 2, about the transaction and the transfer of rights to securities and funds. Through the server transactions with securities 6 save information about the parties to the transaction and actions with the securities.

With reference to FIG. 2, consider the operation of the system and the server calculations 3 in the implementation phase of the calculations.

The settlement server 3 registers the authorized participants of the transaction, forms and registers the account of the participant of the transaction, the trading account of the trader in the trading system, sends the funds 11 from the external account of the trader 1 (from the Bank account) to the trading system to the trading account of the trader 2 and further supplies information 13 about the funds from the trading account of the trader 2 to the settlement server 3, then transfer the information 22 to the broker (dealer) server 10 through the settlement server 3, then transmit the information 31 via the broker (dealer) server 10 on the terminal of the trader. The settlement server 3 delivers information 20 about the fixation of funds in the trading account of the trader 2 for the purchase of securities to the server of transactions with securities 6 of the trading system and receives information 19 from the server of transactions with securities 6 of the trading system about the transaction. Settlement server 3 receives information 21 about transactions from the broker (dealer) server 10.

Settlement server 3 performs all calculations, payments, and delivers information to the trader's trading account 2 about changes in cash rights resulting from the sale and/or purchase of a securities.

The settlement server 3 records the cash 14 on the trading account of the trader-seller of the security 2 and writes off the funds 13 from the trading account of 2 trader-buyer of the securities. Settlement server 3 deduces funds 12 from the trading system through trading account of Trader 2 on the external account of trader 1 (bank account). The settlement server 3 calculates and writes 32 to the account 50 of funds. This is a reward for the provided work done under the terms of the trading system. Through the settlement server 3 write off 33 funds from the accounts of the participants of the transaction 50 for the services rendered to them by the trading system to participate in the bidding under the terms of the trading system. Settlement server 3 protects and stores information about the sides of the transaction and actions with funds.

There can be securities and/or cash on the trader's trading account.

With reference to FIG. 2, consider the functioning of the system and the broker (dealer) server. The broker (dealer) server 10 is represented by a software and hardware complex accepting applications 30 for buying and/or selling securities from the trader's terminal 7.

Through the server of the broker (dealer) 10 receive information 28 including about the securities from the server of transactions with securities 6 of the trading system. The broker (dealer) server 10 is presented to receive information 22 on transactions and settlements from the settlement server 3. The broker (dealer) server 10 is submitted to transfer information and requests 29 to buy and/or sell securities to the securities transaction server 6 of the trading system.

The broker (dealer) server 10 sends information 31 about transactions and securities to the trader's terminal 7. The broker (dealer) server 10 transfers 21 transactions information to the settlement server 3. The broker (dealer) server 10 provides protection and retention of the parties to the transaction and actions with funds.

With reference to FIG. 2, consider the functioning of the system and the terminal of trader 7. Terminal Trader 7 is represented by software and hardware complex by means of which submit bids 30 for purchase and/or sale of a security, orders on cancellation of purchase and/or sale of the security on the server of the broker (dealer) 10 and further of this application 29 on the server securities transactions 6 of the trading system.

Terminal 7 is presented to receive information about the transfer of funds 11 from the external account of the trader 1 to the trading account of the trader 2 and information 12 about the transfer of funds to the external account of the trader 1, through the trading account of the trader 2 of the trading system, by transmitting information 13 from the trading account of the trader 2 to the settlement server 3 and further information 22 to the broker (dealer) server 10 and further information 31 to the trader's terminal 7. Terminal 7 is presented to the receiving information 31 about the sale and/or purchase of a security from the broker's server (dealer) 10 incoming 28 from the server of transactions with securities of 6 trading system. Terminal 7 is designed to preserve and protect information.

FIG. 3—illustrates the block diagram of the third system variant and the method for its implementation.

Referring to FIG. 3, the third variant of the system includes: an authorization and securitization preparation server, performed by a software/hardware complex 4, performing the authorization and securitization preparation step; securitization server executed by hardware-software complex 5, for the implementation of the securitization stage of the created object and the securitization stage of the being created object; the server of securities transactions represented by software and hardware complex 6, for the implementation of the stage of circulation of securities; server of settlement presented by software-hardware complex 3, for the implementation of the stage of settlement; depositary server represented by software and hardware complex 9, for the implementation of the securities accounting stage; broker (dealer) server represented by software and hardware complex 10, for the implementation of competent interaction of traders with the trading system; terminal of trader 7 represented by software and hardware complex, for the interaction of the trader with the broker (dealer) server 10; trading account of trader 2, for crediting and storing cash and/or securities and transactions; trader's external account 1, for depositing and withdrawing funds into and out of the system; accounts of participants in the transaction 50, for settlements between direct and indirect participants in the transaction and the trading system.

Referring to FIG. 3, the methods for operating the authorization server and preparing securitization 4, performing the authorization and preparation stage of securitization in the third system version, are similar to those described earlier in the operation of the first system variant according to the flowchart of FIG. 1.

The third variant of the system and method of its implementation includes the depositary server 9.

Referring to FIG. 3, we consider the functioning of the system and the securitization server in the implementation of the securitization step of the object being created.

Through the securitization server 5, information 17 is received from the authorization server and securitization preparation 4. With the securitization server 5, at the securitization stage of the object being created, securities are formed, including derivatives of the basis asset and/or the obligation to sell the basis asset an object. Through the securitization server 5, an identifier S is generated for each securities that is complementary to the identifier generated by the authorization server and preparation of the securitization 4, for example: the SABCDE identifier of the security/trader/seller/newly created object/basis asset/burden. Through the server securitization 5 register, protect, save and transmit information 34 to the server of the depositary 9.

Referring to FIG. 3, we consider the functioning of the system and the securitization server in the implementation of the securitization step of the created object.

By means of the securitization server 5, information 17 is received from the authorization server and securitization preparation 4. With the help of the securitization server 5, the right to an object is divided into the right of ownership and the right to own capital. The right of ownership determines the constituent of the right to an object, as the right to use the object and possession of this right.

The right of equity to an object determines the constituent right to an object as the right to material and other investments in this object and the ownership of this right. On the securitization server 5, securitize the right of ownership and the right of own capital to an object in securities, including derivatives of the basis asset and/or obligation to sell the basis asset and/or encumbrance of the seller's rights to the object.

Through the securitization server 5 generate an identifier for each securities, including the Q ID of the property right and the ID of the equity right equity, complementary with the ID Generated by the authorization server and preparation of the securitization 4, receiving the code, for example: QSABCDE—ID of the property ownership—/trader/seller/object/basis asset/encumbrance/or WSABCDE—ID securities of the right equity-/trader/seller/object/basis asset/encumbrance/. Through the securitization server 5 register, protect, store and transmit information 34 to the depository server 9.

Referring to FIG. 3, we consider the operation of the system and the depository server in the implementation of the securities accounting stage.

The depository server 9 is represented by a software and hardware complex, an object for storing securities and information about securities and transactions with them. Securities Depository Server 9 receives 34 information about a securities and/or a securities from a securitization server 5.

Depository server 9 is represented by the custodian, accounting, distribution of securities, updating rights to securities, receiving information 27 about securities and actions on them from the server of transactions with securities of 6 trading system and transmitting information 26 about securities on the server transactions with securities 6 trading system.

With reference to FIG. 3, we shall consider the functioning of the system and the server of transactions with securities 6 during the implementation of the securities circulation stage.

Through the server of securities transactions 6 accept information 26 about securities from the depository server 9, information 18 about the participants and objects of transactions are taken from the server securitization 5. Through the securities transactions server 6 authorize participants and transaction objects. By means of the server of transactions with securities 6 accept 29 applications of purchase and/or sale of the security from the broker's server (dealer) 10.

If the object is real estate, the broker (dealer) representative of the trading system may be a authorized dealer and/or real estate agency having a relevant permit or license.

Through the server of transactions with securities 6, the trading system receives information 20 about synchronizing settlements of transactions from the settlement server 3. On the server of transactions with securities 6 of the trading system, a purchase and sale transaction of a securities is recorded when supply and demand match.

Through the server of transactions with securities 6 trading system inform 27 on the server of depository 9 about the transaction with securities and change of rights, inform 19 on the server of settlements 3 about the transaction with securities, inform 28 by means of communication channel on server brocker (dealer) 10 about the transaction with securities, inform 51 on trading account of trader 2, on the fulfillment of the transaction and transfer of rights to securities and funds. By means of a server of transactions with securities 6 store the information on the parties of the transaction and actions with a securities.

With reference to FIG. 3, the third variant of the trading system also includes the broker's server (dealer) 10, the server of calculations 3, terminal of trader 7, trading account of trader 2, the external account of trader 1, accounts of participants of transaction 50, thus in the third variant of system on these servers of the system in the ways of their functioning at the appropriate stages, the same procedure of actions and functions is carried out as they are described above in the functioning of the system according to the structural scheme illustrated FIG. 2. Real Estate Company, Real estate agency, or licensed company can perform the functions of a broker and keep the server broker 10, as well as accept and betray 25 information on the authorization server and the preparation of securitization 4. Trading in securities can be carried out in the form of direct sale, in the form of an auction and through exchange, including specialized.

The way of realization of deals in the proposed invention is shown on the example of real estate object. First of all, the seller of the object accesses the authorization server and preparation of securitization 4 through its terminal and provides information 25 about the object for sale (for example, dwelling, house, office building or commercial building) on Server 4. Information can be easily delivered, for example, through the use of Web documents on the website.

The owner of the rights to create a real estate object and/or the formation of a land parcel transmits, including through communication channels all information 25 about the object, its evaluation, the rights to create it and/or the formation of the server authorization and preparation of securitization 4.

The system uploads data for technical analysis, which is loaded daily into the program. Data is available for any liquidity statistics for the period. You can call a financial analyst to hear recommendations for a fall in growth forecasts for a bargain or sale. Analytical data can be downloaded as tables to a file for convenience. You can track the current changes in table data online, compare it with other tabular data to quickly analyze the market situation.

The form of securitization for the created and for the created objects may be different.

In some jurisdictions, an individual can securitize an object belonging to him, in other jurisdictions only a legal entity can securitize. Perhaps in this case, as an option, for an individual, an organizational-legal form of a legal entity including its object is made securitization.

Due to introduction of the invention, including the claims of the stage of encumbrance of rights, both on the created object and on the object being created, including the object of real estate and/or plot of land, the task of improving the reliability and security of transactions is solved.

Also the technical problem is solved by introduction into the invention, including in the claims of the stage of formation of the basic asset for object and/or the being created object of real estate and/or the formed plot of land, as well as by introduction into invention, into the claims of the stage of formation of derivative securities from the basis asset to the created object and/or the being created object, including the object of real estate and/or a plot of land and/or other object, including indices of value, derivatives from securities of the basis asset.

The system of transactions with objects, including with the being created objects in the ways of its implementation, uses for the securitization and carrying out of protected transactions any objects, not only, and not so much real estate objects.

The present invention solves the problem of debt obligations, credit and other claim requirements between subjects, by bringing the rights and claims of subjects to an object into an equilibrium state, dividing the rights to an object to ownership and the right to own capital, securing these rights and their separate protected sales.

The novelty of this invention is that the system, by means of software and hardware, divides the whole right to the object, to the right of ownership, which determines the component of the right to object, as the right to use the object and possession of this right, and the right Equity on the object, which determines the component of the right to the object, as the right to material and other investments in the object and ownership of this right.

Currently, this invention may be applied to objects of Russia in the relations of subjects of Russia and Japan. Solves the problem of rights and claims. The ownership of the objects remains with Russia, and the right of own capital to the objects is transferred or sold to Japan. Thereby resolving more than half a century of claim issue, the issue of ownership and sharing of objects.

Despite the fact that the invention has been shown and described with reference to a certain kind of preferable variants of its implementation, experts in this field of technology will be understood that various changes in form and content can be produced in Without leaving the essence and scope of the invention.

1. The system of transactions with objects, including the objects being created using the terminals of traders connected through the communication network containing: the securitization server dividing the right; the securities transactions server to provide information about the security from the securitization server, information about the sale of the security from the trader's terminal, together with information about the appraised price, and purchase of the security in response to the purchase request from the trader's terminal, characterized in that contains:
the server for the authorization and the securitization preparation is executed by the software and hardware complex that receives information about the object and its trader, authorizing the participants, generating the form of securitization of the object, dividing the object and/or the object being created on the basis of its number of base assets-units of its measurement, forming the valuation of assets, the obligation of sale, securitization, encumbrance of the rights of the seller to the object, registering the encumbrance, generating identifiers for the parties and objects of the transaction, storing the information in the database, transferring information to the securitization server,
at the same time, the securitization server is represented by the software-hardware complex receiving information from the server for the authorization and the preparation of the securitization, forming for the deal with the object, including the object being created, securities, including derivatives from the underlying asset and/or the obligation to sell the underlying asset and/or the encumbrance of the seller's rights to the object, including the object being created, securities, divided right to the property in securities and the right of own capital, generating securities identifiers that are complimentary with identifiers, generated by the server for the authorization and the securitization preparation, storing the information in the database that transmits information to the server of securities transactions, as well as the securitization server includes a hardware and software complex dividing an object, its basic assets, securities, including securities of ownership, equity right and/or derivatives, on securities of the prime-asset cost and securities of the surplus value of the underlying asset, with one right of ownership reflecting the right to one underlying asset within its cost, and one equity right security displays the right to the surplus value of one of the underlying asset,
at the same time, the server of securities transactions is included into the software and hardware complex of the trading system and is executed by the authorizing all parties and objects participating in the transaction, receiving the information from trading account of the trader about possibility of purchase and/or sale of a security, which accepts the information of confirmation of the opportunity of the transaction from the calculation server, processing the purchase and/or sale orders taken from the trader's terminal, registering the completion of the purchase and sale transaction of the security, when demand and supply match, informing to the server of calculations and trading account of the trader about the completion of the transaction and transfer of rights to securities and own capital, protecting and preserving all information in the database;
the calculation server is executed by the software-hardware complex of trading system registering authorized participants of the transaction, forming and registering the account of the participant of the transaction, the trading account of the trader, making the transaction of funds from the external account of the trader to the trading system, into the trading account of the trader, supplying the information from the trading account to the trader's terminal, making all calculations and payments supplying information about the change of funds rights, resulting from the sale and/or the purchase of the security, recording this information on the trading account of the trader-seller of the security and writing it off from the trading account of the trader-buyer, withdrawing funds from the trading system through the trading account of the trader to the external account of the trader, calculating the remuneration and making the transactions of these funds to the participants of the transaction on their accounts, ensuring the preservation and protection of information about transactions parties and actions with funds;
at the same time, the trader's terminal is represented by the software and hardware complex of the trader interacting with the trading system, applying for purchase and/or sale of security in the trading system, receiving information about the transaction of funds from the trader's external account or from making the transaction to the trading account of the trading system of the trader through the calculation server, ensuring the preservation and protection of information.

2. The system of transactions with objects, including the objects being created, under the paragraph 1, is characterized in that the system contains the server of the broker executed by the software-hardware complex receiving the information about the security from the server of transactions with securities, accepting applications of purchase and/or sale of the security from the trader's terminal, transferring applications for purchase and/or sale of security to the server of securities transactions of the trading system, transferring information about transactions and securities to the trader's terminal, ensuring the preservation and protection of information;

3. The system of transactions with objects, including the objects being created, under the paragraph 2, is characterized in that the system contains the depository server executed by the software-hardware complex, receiving the information from the server for the securitization, keeping records, distribution of securities, updating rights on securities, receiving Information about securities and actions on them from the server of transactions with securities and transmitting information to it, ensuring the preservation and protection of information.

4. The method of dividing the object for the system of transactions with objects, including the objects being created, which uses securities for functioning in the trading system, dividing the object into the underlying assets-units of its measurement, as well as divide the whole right to the object on the components by functions, where the right of ownership determines the component of the right to object, as the right to use the object and ownership of this right, and the right of own capital to the object determines the component of capital in this object, securitizating derivative divisions in securities, including securities of the prime cost of the underlying asset and securities of the surplus value of the underlying asset, with one security of ownership reflecting the right to one underlying asset within its cost, and one equity right displays the right to the extra value of one underlying asset.

5. The method of transactions with vows containing: the stage of securitization on which the right is divided; the stage of circulation of the security, on which receive, through the server of transactions with securities, information about the security from the securitization server or information about the sale of securities from the trader's terminal, supply information about the security together with information on the valuation of assets on the trader's terminal and supply information about the change of rights, resulting from the sale, characterized in that it contains the stage of the authorization and preparation of securitization, on which through the server for the authorization and the preparation of securitization receive the information about the object and its trader, authorize the participants, generate them identifiers, including the identifier of the trader-buyer, the trader-seller and the object identifier, divide the object into the number of base assets-units of its measurement, form the valuation of assets, form and obligation of securitization, encumbrance of the rights of the seller to the object, generate identifiers for the parties and objects of the transaction, the information obtained register, retain in database, then transfer to the securitization server,
at the stage of securitization, by means of the server of securitization receive the information from the server for the authorization and the preparation of securitization, and securitize the divided right to the property and the right of own capital, while form securities, including derivatives of underlying assets and/or liabilities for the sale of underlying assets and/or encumbrance of the seller's rights to the object, generate for each security an identifier that is complimentary with identifiers generated by the server for the authorization and the securitization preparation, the received information is registered and stored in the database, the received transfer to the server for transactions with securities of the trading system, as well as at the stage of the securitization, through the securitization server, divide the object, its underlying assets, securities, including securities of ownership rights, equity rights and/or derivatives on securities of the underlying asset cost and securities of surplus value of the underlying asset, with one security of ownership reflects the right to one underlying asset within its cost, and one equity right of equity displays the right to the surplus value of one underlying asset,
at the stage of circulation of security through the server of transactions with securities of the trading system, authorize all parties and objects participating in the transaction, receive the information from the trading account of the trader about the possibility of buying and/or selling securities, receive the information of confirmation of the opportunity of the transaction from the calculation server, process applications accepted from the trader's terminal, register the completion of purchase and sale of security when the demand and supply match, inform the server of calculations and the trading account of the trader about the transaction and transfer of rights to securities and own capital, provide exchange of information between the parties of the transaction, the server of transactions with securities of the trading system, the calculation server, the trader terminal, provide protection and preservation of information;
the stage of settlements and circulation of funds on which through the calculation server, register authorized participants of the transaction, form and register the account of the participant of the transaction, the trading account of the trader in the trading system, receive and contribute Funds in the trading system to the trader's trading account, supply the information about it to the trader's terminal, make calculations, payments, accept and supply information about the change of rights to the funds, resulting from the sale and/or purchase of security on the server of securities transactions, trader's trading account, write down information about funds to the seller's account and write off the buyer's account, accept funds to the trading account of the trader, withdraw funds from the trading system to the external account of the trader, the participant of the transaction, calculate the reward, write it off from the trader's account and write it to the account of each participant of the transaction for the work, provide protection and preservation of information about the parties of the transaction and actions with funds.

6. The method, according to the paragraph 5, is characterized in that, at the stage of calculations make division and receiption, through the server of calculations, dividends from profit of use of the object which is divided between securities of ownership and securities equity rights in accordance with their shares in the object and/or predetermined dividend conditions.

7. The method, according to the paragraph 5, is characterized in that, in the stage of circulation of the security and in the stage of payments and circulation of funds, the broker server is executed by the software-hardware complex, receiving information about the security from the transactions server with securities, which receive applications for purchase and/or sale of securities from the trader's terminal, which transfer the application for purchase and/or sale of securities to the trading system securities of the transaction server, which transmits information about transactions and securities to the terminal, ensuring the preservation and protection of information.

8. The method, according to the paragraph 7, is characterized in that it contains the stage of accounting of securities, on which through the depository server, receive information from the server of the securitization, keep records, distribution, receive, transfer information about securities to the parties of trades, store information about securities and actions with them, provide protection and preservation of information on the parties of the transaction and actions with the security.

9. The method of transactions with objects containing: the stage of securitization; the stage of circulation of the security, on which receive, through the server of transactions with securities, information about the security of the securitization server or information about the sale of securities from the trader's terminal, supply information about the security together with information about the valuation of assets on the trader's terminal, characterized in that conduct transactions with the objects being created, including the real estate objects being created and/or the formed land plots, contains:
the stage of the authorization and preparation of securitization, on which through the server for the authorization and the preparation of securitization, accept information about the object being created and its trader, authorize the participants, generate identifiers, including the identifiers of trader-buyer, trader-seller and the identifier of the object being created, divide the object being created, on the number of the basic assets-units of its measurement, form the valuation of assets, the form and the obligation of securitization, encumbrance rights of the seller to the created object, generate identifiers for the parties and objects of the transaction, the obtained information is registered, stored in the database, then transferred to the server securitization,
at the securitization stage, through the securitization server, accept information from the server for the authorization and the securitization preparation and form securities, including derivatives from the underlying asset and/or the obligation to sell the underlying asset and/or encumbrance of the seller's rights on the object being created, generate for each security the identifier complimentary with the identifiers generated by the sever for the authorization and the securitization preparation, the received information is registered and retained in the database, the received transfer to the transactions server with securities of the trading system, and the depository server,
at the stage of circulation of security, through the server of transactions with securities of the trading system, authorize all parties and objects involved in the transaction, receive the information from the trading account of the trader about the possibility of buying and/or selling securities, receive the information of confirmation of the opportunity of the transaction from the calculation server, process applications accepted from the trader's terminal, register the completion of purchase and sale of security when the demand and supply match, inform the server of calculations and the trading account of the trader about the transaction and transfer of rights to securities and own capital, provide exchange of information between the parties of the transaction, the server of transactions with securities of the trading system, the calculation server, the trader terminal, provide protection and preservation of information;
the stage of settlements and circulation of funds, on which through the calculation Server, register authorized participants of the transaction, form and register the account of the participant of the transaction, the trading account of the trader in the trading system, receive and contribute Funds in the trading system to the trader's trading account, supply the information about it to the trader's terminal, make calculations, payments, accept and supply information about the change of rights to the funds, resulting from the sale and/or purchase of security on the server of securities transactions, trader's trading account, write down information about funds to the seller's account and write off the buyer's account, receive funds to the trading account of the trader, withdraw money from the trading system to the external account of the trader, the participant of the transaction, calculate the reward, write it off from the trader's account and write it to the account of each participant of the transaction for the work, provide protection and saving of information about the parties of the transaction and actions with funds.

10. The method, under the paragraph 8, is characterized in that it contains the expiry stage, including the process of completion of the circulation of securities, fixed-term contracts, when the completion of the object as a whole is carried out the transfer of securities to the ownership of the object.

11. The method, according to the paragraph 8, is characterized in that, in the stage of circulation of the security and in the stage of payments and circulation of funds the broker server is executed by the software-hardware complex receiving information about the security from the transactions server with securities, which receive applications for purchase and/or sale of securities from the trader's terminal, which transfer the application for purchase and/or sale of securities to the trading system Securities of the Transaction Server, which transmits information about transactions and securities to the terminal ensuring the preservation and protection of information.

12. The method, under the paragraph 11, is characterized in that it contains the stage of accounting of securities, on which through the depository server receive information from the server of the securitization, keep records, distribution, receive, transfer information about securities to the parties of trades, store information about securities and actions with them, provide protection and preservation of information on the parties of the transaction and actions with the security.
